(19) United States
(12) Patent Application Publication
(10) Pub. No.: US 2017/0000274 A1
(43) Pub. Date: Jan. 5, 2017

(54) Device for Diluting Solid Products in a Liquid Medium

(71) Applicant: EFUSIONES SPAIN, S.L., Valencia (ES)

(72) Inventor: Fermín Enrique Chulilla Esteva, Valencia (ES)

(21) Appl. No.: 15/039,876

(22) PCT Filed: Nov. 27, 2014
(86) PCT No.: PCT/ES2014/070871

§ 371 Date: May 27, 2016

(30) Foreign Application Priority Data
Nov. 29, 2013 (ES) U201331377

(51) Int. Cl. A47G 19/16; B25G 1/10; B01F 1/00; B01F 13/00

(52) U.S. Cl. CPC A47G 19/16; B01F 13/002; B25G 1/102; B01F 1/0011; B01F 2215/0022; B01F 2215/0032

(57) ABSTRACT

The invention concerns a device for diluting solid products in a liquid medium, wherein it comprises a handle comprising: a base in the lower part of the handle and a grip in the upper part of the handle; a bag of filter material comprising the solid product to be diluted; and a body which is open at the bases thereof and accommodates in the interior the bag of filter material. The device comprises means for coupling the base and the body.

### OBJECT OF THE INVENTION

The object of the present invention refers to a device for diluting solid products such as sugars, sweeteners, infusions, medicine or any dose of any product in general that can be diluted in a liquid medium in a simple and easy way.

It is of particular use in the industry devoted to manufacturing equipment for dispensing solid products in doses.

### TECHNICAL PROBLEM TO ADDRESS AND BACKGROUND OF THE INVENTION

Nowadays, in order to make an infusion from pre-packaged doses it is common to use bags made of closed paper or filter material containing the dose of herbs or products, which are placed inside a mug or cup containing hot water, in which the infusion is made. In order to remove the bag easily, it features a string or cord attached to a label or gripping component that is arranged outside, and which is made of a piece of cardboard or similar. Thus, when the infusion is drunk, the small bag is removed from the cup by pulling the cardboard portion and the string.

The main problem with this dosage is that the bag and the product contained therein are soaked in water and drip when they are removed from the cup, and they can even stain, which is quite bothersome.

In other cases, the container comprises a flexible and elongated tubular body made of a water resistant material with perforated walls, such that, once it is inserted in the cup, the upper end remains outside the rim of the cup and can be easily picked up, while the infusion takes place as hot water comes in and out through the lateral perforations. This presents a hygiene problem, especially when the upper part of the device is only just protruding from the water level wherein the brewing takes place and users can get their fingers wet.

In other cases, the dose of the infusion is compressed with a spoon or a similar device, a process that makes it difficult to drain the bag properly in order to prevent it from dripping.

Another problem with this type of inventions is that water flows slowly through them, such that in order to make a good infusion the bag needs to remain in hot water for a relatively long period. This makes it common to see users inserting and removing the bag in the water, that is, giving the bag a changing vertical motion that improves how water penetrates it and that, in consequence, speeds up the process of making the infusion.

As explained above, the results obtained with this type of inventions do not give the expected outcomes.

Therefore, the present invention solves the aforementioned problems of the state of the art, providing a device that has the following advantages:

1. Since it is stirred as if it was a spoon, the high speed at which it is stirred helps the liquid to quickly flow in and out of the device, infusing the water with the essences detached from the solid product.

2. It excels at allowing the liquid to penetrate inside the device and mix it with the solid product.

3. The filtering material retains any solid impurity (dregs) preventing the product from losing its quality, resulting in a more comfortable experience for the user.

4. Since it features a handle with a base, it can also compress the solid product in order to improve its dilution, as well as act as a spoon to dilute any other solid product added beforehand or afterwards.

### DESCRIPTION OF THE INVENTION

The present invention refers to a device for diluting solid products in a liquid medium, comprising:
a handle that also comprises:
   a base in the lower part of the handle, and
   a grip in the upper part of the handle,
a bag of filter material comprising the solid product to be diluted, and
a body which is open at the bases thereof and accommodates in the interior the bag of filter material,
   wherein the device comprises means for coupling the base and the body.

The base is comprised of a first base, a second base, and a third base.

The body is comprised of an annular body, a first tubular body, and a second tubular body.

The means for coupling the first base and the annular body are a peripheral tongue-and-groove coupling.

The bag of filter material comprises tabs in order to secure it to the annular body.

The first tubular body is formed by two halves joined together by means for fastening them.

The means for coupling the second base and the first tubular body comprise a plurality of notches arranged on the second base and a plurality of guides arranged longitudinally through the first tubular body such that the handle slides over the guides of the first tubular body.

The second tubular body is comprised of a single component.

The third base comprises an upper sheet and a lower sheet arranged in parallel so that said sheets are separated by a central partition wall.

The means for coupling the third base and the second tubular body comprise stops on the upper edge of the second tubular body.

The connection between the handle and the third base, and the connection between the central partition wall and the sheets are reinforced by ribs.

The tubular bodies comprise:
a plurality of holes on the lateral walls, and
a lower base comprising a plurality of holes, such that the diluted solid product can come out of the device.

The handle and the body are made of a material selected between plastic, polypropylene and fibreglass reinforced plastic.

The bag of filter material is made of a material selected between porous paper, silk or nylon.

### BRIEF DESCRIPTION OF THE FIGURES

To complete the description and in order to give a better understanding of the characteristics of the invention, this descriptive report is accompanied by a series of drawings that are an integral part of the report, wherein, for illustration purposes and without limitation, the following has been represented:

FIG. 1 shows an exploded front view of the assembly of the components forming the device for diluting solid products in a liquid medium according to the first embodiment of the invention.

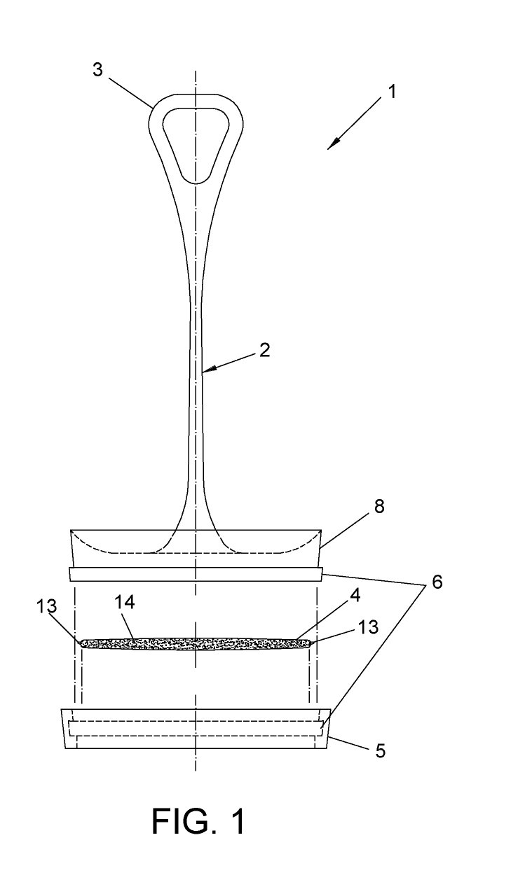

FIG. 2 shows a front view of the components forming the device for diluting solid products in a liquid medium once they have been assembled according to the first embodiment of the invention.

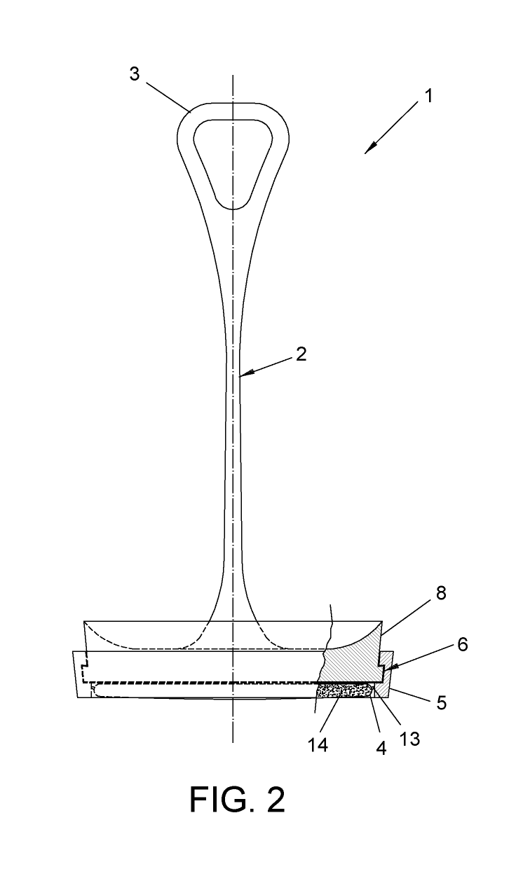

FIG. 3 shows an exploded perspective view of the assembly of all the components forming the device for diluting solid products in a liquid medium according to the second embodiment of the invention.

FIG. 4 shows a perspective view of the components forming the device for diluting solid products in a liquid medium once they have been assembled according to the second embodiment of the invention.

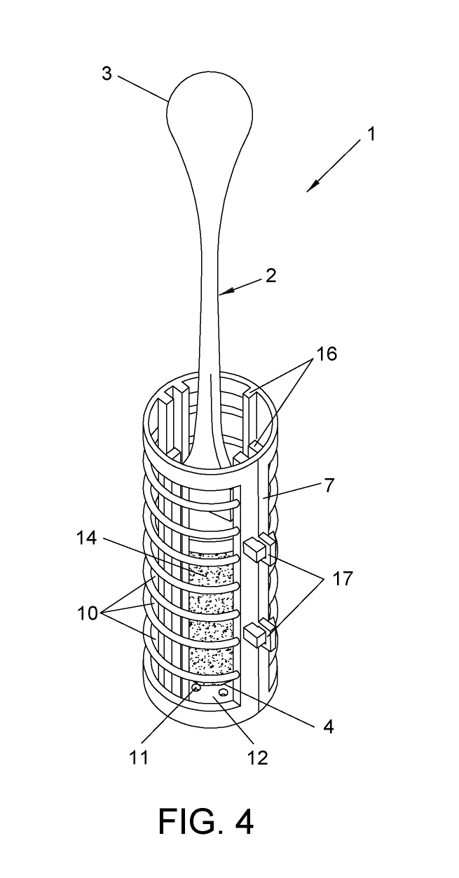

FIG. 5 shows an exploded perspective view of the assembly of all the components forming the device for diluting solid products in a liquid medium according to the third embodiment of the invention.

FIG. 6 shows a perspective view of the components forming the device for diluting solid products in a liquid medium once they have been assembled according to the third embodiment of the invention.

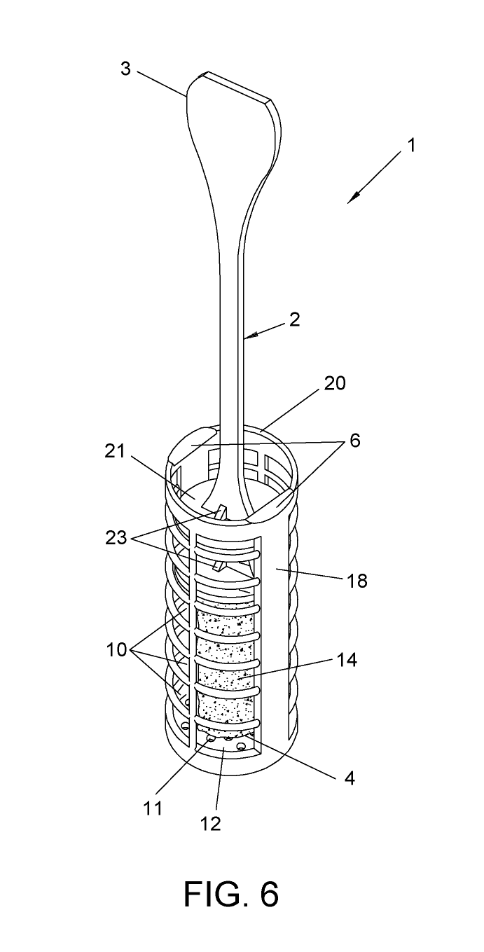

A list of the different components that have been represented in the drawings and that comprise the invention is detailed below:

1. Device for diluting solid products in a liquid medium.

2. Handle.

3. Grip.

4. Bag of filter material.

5. Annular body.

6. Means for coupling.

7. First tubular body.

8. First base.

9. Second base.

10. Lateral holes.

11. Holes.

12. Lower base of the tubular body.

13. Tabs of the bag of filter paper.

14. Solid product.

15. Notches.

16. Guides.

17. Means for closure.

18. Second tubular body.

19. Third base.

20. Upper edge of the second tubular body.

21. Upper sheet.

22. Lower sheet.

23. Ribs.

24. Central partition wall.

### DETAILED DESCRIPTION

The present invention is a new device (1) for diluting solid products (14) such as sugars, sweeteners, infusions, medicine or any dose of any product in general that can be diluted in a liquid medium.

In this application, “diluting” is understood as dissolving a solid product and subsequently diluting it in a liquid medium, for example medicine, as well as extracting components from a solid product and subsequently diluting said components in a liquid medium, such as for example, tea and coffee.

The device (1) is introduced in a container with the diluting liquid medium at a high temperature, so that the solid product (14) is diluted in the liquid medium and is stirred as if using a spoon, helping it to dissolve.

The diluting liquid medium can also be cold water, alcohol or any other liquid medium.

According to a first embodiment of the invention, the device (1) comprises:
a long handle (2) comprising:
   a first base (8) in the lower part of the handle (2), and
   a grip (3) in the upper part of the handle (2) with an ergonomic shape so that it is very comfortable for the user,
a bag of filter material (4) comprising the solid product (14) to be diluted, and
an annular body (5) that accommodates the bag of filter material (4),
   wherein the device (1) comprises a means for coupling (6) the first base (8) and the annular body (5).

The means for coupling (6) are preferably of the peripheral tongue-and-groove couplings, such as press-fit, threaded or snap-fit closures.

The bag of filter material (4) comprises tabs (13) that fit in the annular body (5) to be secured.

The annular body (5) is preferably shaped like a ring but it can also be shaped in any other geometric way that is complementary to the shape of the first base (8).

According to a second embodiment of the invention, the device (1) comprises:
a long handle (2) comprising:
   a second base (9) in the lower part of the handle (2) wherein said second base (9) comprises a plurality of notches (15), and
   a grip (3) in the upper part of the handle (2) with an ergonomic shape so that it is very comfortable for the user,
a bag of filter material (4) comprising the solid product (14) to be diluted, and
a first tubular body (7) that accommodates in its interior the bag of filter material (4),
   wherein the device (1) comprises means for coupling (6) the second base (9) and the first tubular body (7).

The first tubular body (7) comprises a lower base (12).

The means for coupling (6) comprise a plurality of notches (15) arranged on the second base (9) and a plurality of guides (16) arranged longitudinally through the first tubular body (7) so that the handle (2) slides on said guides (16) and allows for pressing the bag of filter material (4) against the lower base (12) of the first tubular body (7), thus quickly releasing the essences of the solid product (14).

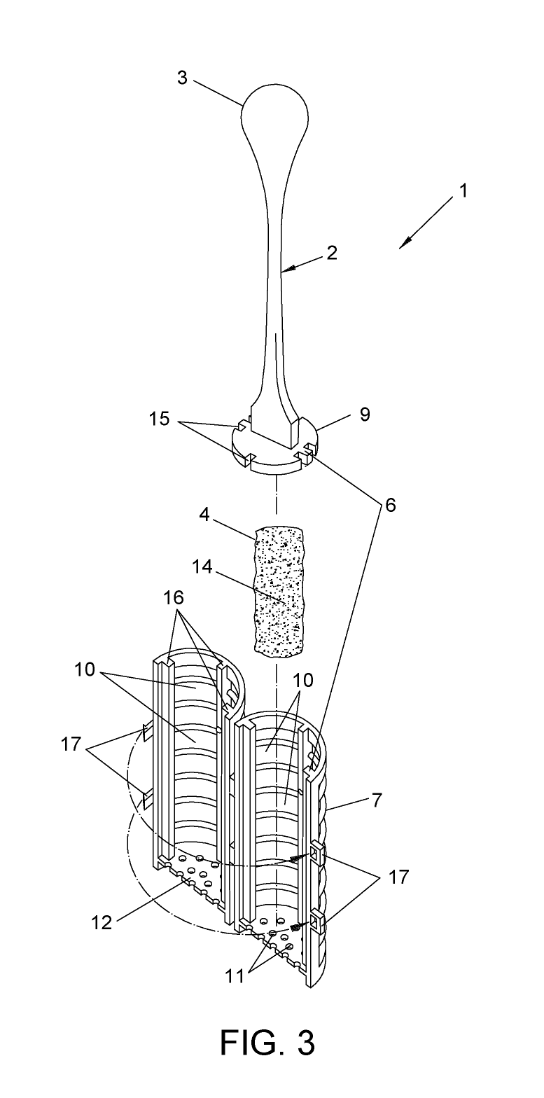

The first tubular body (7) is formed by two halves that are joined together by means for closure (17) them, where these means for closure (17) can be any known mean, such as press-fit or snap-fit closure, as shown in FIG. 3. Naturally, the first tubular body (7) could be formed by a single component or by more components.

The first tubular body (7) could incorporate a lid placed after the handle (2) is inserted in the cup such that the compression could be carried out upwards or downwards, depending on where the solid product (14) is placed.

The first tubular body (7) could comprise a filter material along the length of the outer perimeter of the first tubular body (7).

According to a third embodiment, the device (1) comprises:
a long handle (2) comprising:
   a third base (19) in the lower part of the handle (2), wherein said third base (19) comprises an upper sheet (21) and a lower sheet (22) arranged in parallel and wherein said sheets (21, 22) are separated by a central partition wall (24), and
   a grip (3) in the upper part of the handle (2) with an ergonomic shape so that it is very comfortable for the user,
a bag of filter material (4) comprising the solid product (14) to be diluted, and
a second tubular body (18) that accommodates in its interior the bag of filter material (4),
   wherein the device (1) comprises means for coupling (6) the third base (19) and the second tubular body (18).

The second tubular body (18) comprises a lower base (12).

The connection between the handle (2) and the third base (19), and the connection between the central partition wall (24) and the sheets (21, 22) are reinforced by ribs (23).

The means for coupling (6) comprise a series of stops on the upper edge (20) of the second tubular body (18) that prevent the handle (2) from being inserted or removed unless the user wants to do so for which he/she will need to press said stops.

In this third embodiment, the handle (2) slides longitudinally through the second tubular body (18) and can compress the bag of filter material (4) against the lower base (12) of the second tubular body (18), thus quickly releasing the essences of the solid product (14).

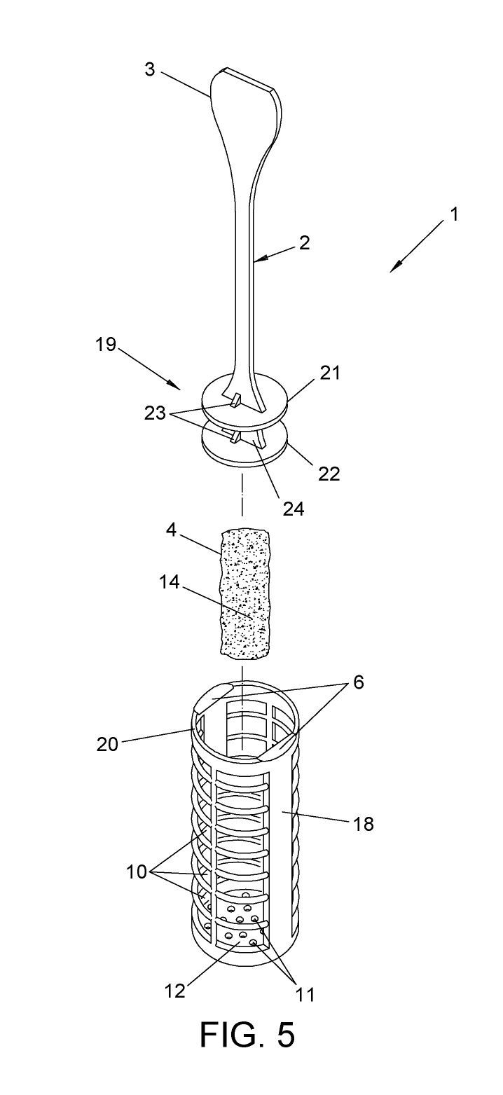

The second tubular body (18) is formed by a single component as displayed in FIG. 5, providing the assembly with greater rigidity. Naturally, it could be formed by more than one component. Since this is a small component, it is easy and inexpensive to mould.

The tubular bodies (7, 18) are preferably shaped like cylinders but they can also be shaped in any other geometric way that is complementary to the shape of the base.

Likewise, the tubular bodies (7,18) comprise a plurality of lateral holes (10) arranged on the lateral walls and a series of small holes (11) on the lower base (12) that allow the essences of the solid product (14) to come out of the device (1).

The bag of filter material (4) can be made of any material, preferably porous paper, silk or nylon. The bag of filter material (4) can have different shapes according to the geometric shape of the container where it is accommodated.

In the three embodiments, the handle (2) can compress the bag of filter material (4) with the solid product (14) against the bottom and/or the walls of the container of the liquid medium.

The bodies (5,7,18) and the assembly of the handle (2) are preferably manufactured using materials selected between plastic for use with foodstuffs, polypropylene and fibreglass reinforced plastic, though they can be manufactured using any other material.

The device (1) for diluting solid products (14) in a liquid medium that is the object of the invention features significant improvements in comparison with conventional devices and provides very simple and efficient solutions for the problems and disadvantages of the aforementioned devices known in the state of the art.

The present invention is not limited by the embodiment disclosed herein. Other configurations can be made by experts in the art following the present description. In consequence, the scope of the invention is defined by the following claims.

1. A device for diluting solid products in a liquid medium, comprising:
a handle comprising:
a base in the lower part of the handle, and
a grip in the upper part of the handle,
a bag of filter material comprising the solid product to be diluted; and
a body which is open to accommodate the base of the handle therein and housing the bag of filter material;
wherein the base and the body include corresponding engagement portions for coupling the base and the body.

2. The device for diluting solid products according to claim 1, wherein the base includes a plurality of notches.

3. The device for diluting solid products according to claim 1, wherein the body comprises an annular body.

4. The device for diluting solid products according to claim 3, wherein the base and the annular body comprise a peripheral tongue-and-groove configuration for coupling the base and the body.

5. The device for diluting solid products according to claim 3, wherein the bag of filter material comprises tabs in order to secure it to the annular body.

6. The device for diluting solid products according to claim 1, wherein the body comprises a tubular body formed by two halves joined together by closure.

7. The device for diluting solid products according to claim 6, wherein the base and the tubular body comprise a plurality of notches arranged on the base and a plurality of guides arranged longitudinally through the tubular body such that the handle slides over the guides of the tubular body for coupling the base and the tubular body.

8. The device for diluting solid products according to claim 1, wherein the body comprises a tubular body made up of a single piece.

9. The device for diluting solid products according to claim 8, wherein the base comprises an upper sheet and a lower sheet arranged in parallel and wherein said upper sheet and lower sheet are separated by a central partition wall.

10. The device for diluting solid products according to claim 9, wherein the base and the tubular body comprise stops on the upper edge of the tubular body for coupling the base and the tubular body.

11. The device for diluting solid products according to claim 10, wherein the connection between the handle and the base, and the connection between the central partition wall and the upper sheet and lower sheet is reinforced by ribs.

12. The device for diluting solid products according to claim 1, wherein the body comprises a tubular body comprising lateral walls having a plurality of holes on the lateral walls, and a lower base comprising a plurality of holes such that the diluted solid product can come out of the device.

13. The device for diluting solid products according to claim 1, wherein the handle and the body are made of a material selected between plastic for use with foodstuffs, polypropylene and fibreglass reinforced plastic.

14. The device for diluting solid products according to claim 1, wherein the bag of filter material is made of a material selected between porous paper, silk or nylon.
